(19) United States
(12) Patent Application Publication
(10) Pub. No.: US 2008/0196051 A1
(43) Pub. Date: Aug. 14, 2008

(54) Cartridge for Photosensitive Recording Medium

(75) Inventors: Tetsuya Takatori, Kanagawa (JP); Tomoyuki Takahashi, Kanagawa (JP); Hidetoshi Kawasaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Minato-ku, Tokyo (JP)

(21) Appl. No.: 11/885,592

(22) PCT Filed: Feb. 28, 2006
(86) PCT No.: PCT/JP2006/304213

§ 371 Date: Sep. 4, 2007

(30) Foreign Application Priority Data
Mar. 2, 2005 (JP) 2005-057830

(51) Int. Cl. G11B 23/03

(52) U.S. Cl. 720/728

(57) ABSTRACT

A cartridge (2) contains a recording disk (4) having photosensitivity. The cartridge comprises a cartridge shell (11), a light shielding plate (12) and a shutter (13). The cartridge shell has an internal opening (18) for exposing a central portion and a recording surface of the recording disk to the outside. The light shielding plate is attached to an outer side of the cartridge shell and has an external opening (14) confronting the internal opening. The shutter is slidably disposed between the cartridge shell and the light shielding plate to open and close the internal opening. A lock mechanism locks the shutter in a closed position. For releasing the lock mechanism, it is necessary to slide a first lock member (63), which is exposed through a cavity (72), in a state that a second lock member (64) projecting into a groove (7) is pushed into the cartridge shell.

### TECHNICAL FIELD

The present invention relates to a cartridge for containing a photosensitive recording medium, and in particular relates to improvement of a cartridge comprising a shutter for closing and unclosing an opening formed in a cartridge shell.

### BACKGROUND ART

A hologram recording medium for recording data by means of a hologram is invented (see Japanese Patent-Laid Open Publication No. 2004-029476, for instance). The hologram recording medium is a photosensitive recording medium comprising a hologram recording layer, which is made of a photosensitive material and is formed on a disk-shaped support. By recording the data in multi layers as interference fringes of a laser beam, it is possible to obtain larger capacity of data storage in comparison with a DVD, which is a conventionally prevailing recording medium. As to this hologram recording medium, performance thereof is adversely affected when the hologram recording layer is exposed to the light and when dust adheres thereto. Thus, the hologram recording medium is contained in a cartridge having light shielding properties and dustproof properties when treated (see Japanese Patent Laid-Open Publication No. 2003-317422, for instance).

In the invention described in the above-noted Publication No. 2004-029476, the hologram recording medium is contained in a cartridge similar to a DVD-RAM cartridge. This cartridge is made of a material having small light transmittance relative to a wavelength region wherein the hologram recording layer is affected. Although the Publication No. 2004-029476 does not teach detailed structure of the cartridge, the structure thereof seems to be similar with that of the cartridge described in the Publication No. 2003-317422.

Regarding the invention described in the Publication No. 2003-317422, the cartridge is made of a material by which the light having a sensitive color of the hologram recording layer is shielded, and a sponge-like light-shielding material is applied to a joint of a movable portion, which is for exposing the hologram recording medium to the outside. Further, the Publication No. 2003-317422 teaches the cartridge comprising a cartridge shell, an opening and a shutter. The cartridge shell rotatably contains the recording medium. The opening is formed in the cartridge shell to expose a part of the recording medium to the outside. The shutter closes and uncloses the opening.

In the case of the cartridge containing the hologram recording medium, if a joint portion of the cartridge shell and the shutter is not properly shielded, light and dust enter the cartridge to adversely affect the hologram recording medium. However, the Publication No. 2004-029476 does not teach a light-shielding structure and a dustproof structure of an interspace residing between the cartridge shell and the shutter. As to the cartridge described in the Publication No. 2003-317422, the interspace of the cartridge shell and the shutter is shielded by the sponge-like light-shielding material. However, in case the light-shielding material is removed or deteriorates, there arises a problem in that it is prevented to properly shield the light and the dust.

Meanwhile, if the shutter is opened at the outside of a device, the hologram recording layer is exposed and becomes unusable. However, the cartridges described in the Publication Nos. 2004-029476 and 2003-317422 have no measure for preventing the shutter from being mistakenly opened.

It is an object of the present invention to provide a cartridge for the photosensitive recording medium in which an interspace of a cartridge shell and a shutter is properly protected from light and dust.

It is another object of the present invention to provide a cartridge for the photosensitive recording medium in which a shutter is prevented from being mistakenly opened.

### DISCLOSURE OF INVENTION

In order to achieve the above objects, the cartridge for the photosensitive recording medium according to the present invention comprises a cartridge shell, a first opening, a light shielding plate and a shutter. The cartridge shell rotatably contains a disk-shaped photosensitive recoding medium. The first opening is formed in the cartridge shell to expose a central portion and a recording surface of the photosensitive recording medium to the outside. The light shielding plate is attached to an outer side of the cartridge shell and has a second opening, which confronts the first opening to expose the center portion and the recording surface of the photosensitive recording medium to the outside. The shutter is disposed between the cartridge shell and the light shielding plate, and has a larger size in comparison with the first and second openings. The shutter is adapted to be movable between a closed position, where the shutter is positioned between the first and second openings, and an open position, where the shutter is moved out of the first and second openings. The first opening is closed by the shutter, and the shutter is covered with the light shielding plate. In this manner, walls for shielding the light are intricately overlapped so that a labyrinth-like light-shielding structure is formed between the first and second openings.

In order to move the shutter disposed between the cartridge shell and the light shielding plate, the shutter is provided with an actuation part to be operated, which is exposed to the outside of the light shielding plate. In virtue of this, it is possible to move the shutter without deteriorating shielding performance of the light shielding plate.

Moreover, in order to prevent the shutter from being mistakenly opened, it is preferable to provide a lock mechanism for locking the shutter in the closed position. The lock mechanism comprises a first lock member and a second lock member. The first lock member is movable between a first lock position, where the shutter is prevented from moving to the open position, and a first release position, where the shutter is allowed to move to the open position. The second lock member is movable between a second lock position, where the first lock member is prevented from moving to the first release position, and a second release position, where the first lock member is allowed to move to the first release position. In virtue of this lock mechanism, the shutter is not opened unless the first lock member and the second lock member are operated in order.

According to the cartridge of the present invention, interspace of the shutter and the opening of the cartridge shell is properly protected from light and dust. Moreover, the shutter is prevented from being carelessly opened.

### BRIEF DESCRIPTION OF DRAWINGS

FIG. 1 is a perspective view showing a cartridge according to the present invention;

FIG. 2 is a perspective view showing an opposite side of the cartridge;

FIG. 3 is a perspective view showing a shutter open state of the cartridge;

FIG. 4 is an exploded perspective view showing a structure of the cartridge;

FIGS. 5A, 5B and 5C are section views of the cartridge taken in a loading direction thereof;

FIGS. 6A and 6B are section views of the cartridge taken in a direction perpendicular to the loading direction;

FIG. 7 is an exploded perspective view showing a structure of a lock mechanism;

FIGS. 8A, 8B and 8C are illustrations explaining an operation of the lock mechanism shown in FIG. 7;

FIG. 9 is an explanatory illustration showing an example of a shutter opening mechanism;

FIG. 10 is an exploded perspective view showing a structure of another lock mechanism;

FIGS. 11A, 11B and 11C are illustrations explaining an operation of the lock mechanism shown in FIG. 10;

FIG. 12 is an exploded perspective view showing a structure of the other lock mechanism; and

FIGS. 13A and 13B are illustrations explaining an operation of the lock mechanism shown in FIG. 12.

### BEST MODE FOR CARRYING OUT THE INVENTION

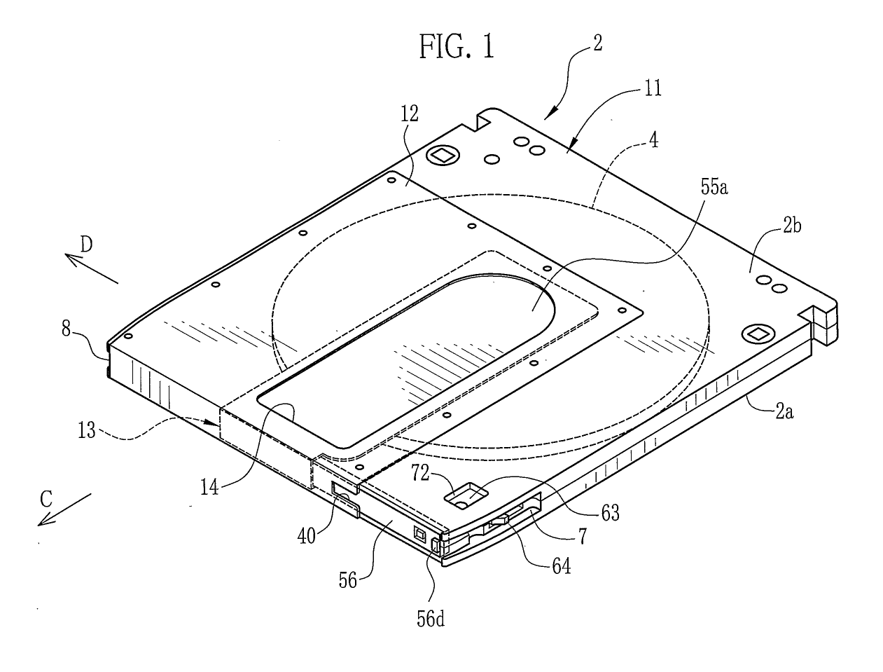

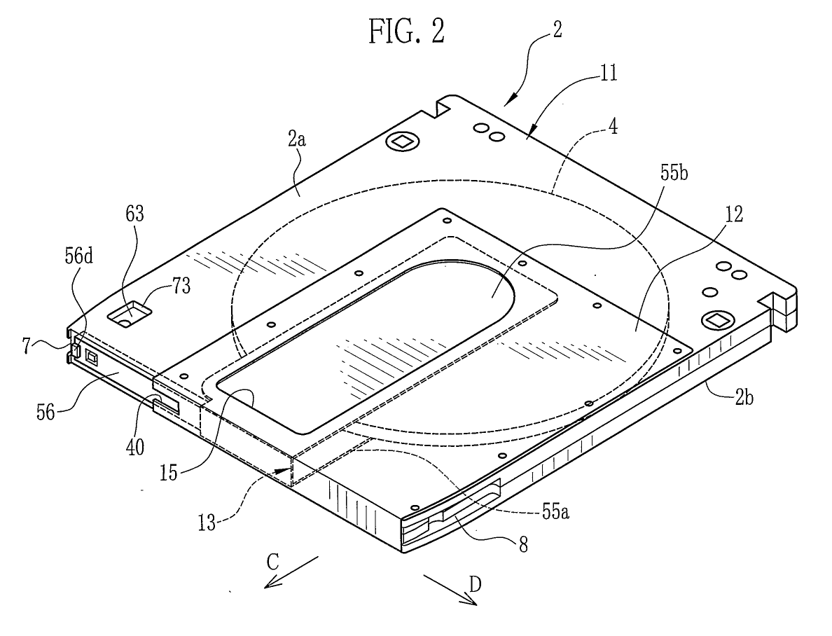

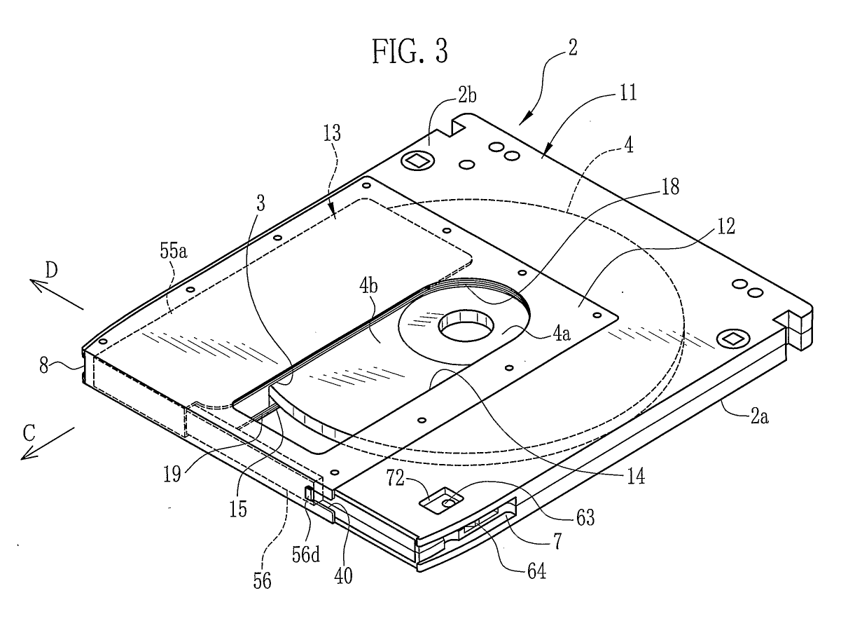

FIGS. 1 to 3 are perspective views showing a cartridge for a hologram recording medium according to the present invention. FIG. 1 shows a state in that one side (B-side) 2b of the cartridge 2 faces upward. FIG. 2 shows a state in that an A-side 2a opposite to the B-side faces upward. The cartridge 2 rotatably contains the disk-shaped hologram recording medium (hereinafter, referred to as recording disk) 4 in an internally-formed disk recess 3 (see FIG. 3).

The cartridge 2 is loaded into a hologram recording device and so forth, which are for dealing with this cartridge, in a direction shown by an arrow C. Both lateral sides of the cartridge 2 are provided with positioning grooves 7 and 8 located at a front portion in the loading direction of the cartridge 2. When the cartridge 2 is loaded in various devices of the hologram recording device and so forth, positioning members of the respective devices are inserted into the positioning grooves 7 and 8.

The recording disk 4 has a hole formed in its central portion. Both surfaces of the recording disk 4 are provided with hologram recording layers in which data is recorded by a laser beam whose wavelength is within a region of green 532 nm to blue 405 nm, for example. The data is recorded in a multilayer manner as interference fringes of the laser beam. Incidentally, a reinforcing member may be attached to the hole of the recording disk 4. The cartridge 2 is set in the hologram recording device to perform recording for both recording surfaces of the recording disk in a state that either of the A-side 2a and the B-side 2b faces upward.

The cartridge 2 comprises a cartridge shell 11 provided with the disk recess 3. The cartridge 2 further comprises a light shielding plate 12 and a shutter 13. The light shielding plate 12 is attached to the cartridge shell 11 so as to interpose an outer side thereof. The shutter 13 is disposed between the cartridge shell 11 and the light shielding plate 12. External openings 14 and 15 substantially having a rectangular shape are formed in upper and lower surfaces of the light shielding plate 12. The external openings 14 and 15 are closed by a first shutter portion 55a and a second shutter portion 55b when the shutter 13 is kept in a closed position.

As shown in FIG. 3, when the shutter 13 is moved to an open position in a direction represented by an arrow D, the external openings 14 and 15 are opened. At this time, internal openings 18 and 19 formed in the cartridge shell 11 are also opened. The internal openings 18 and 19 are formed so as to confront the external openings 14 and 15, and so as to have an identical shape therewith. By virtue of these openings, a central portion 4a and a recording surface 4b of the recording disk 4, which is contained in the disk recess 3, are exposed to the outside.

The shutter 13 is urged by a built-in shutter spring toward the closed position and is locked by a lock mechanism in the closed position. When releasing the lock mechanism, a second lock member 64 projecting into the positioning groove 7 is pushed into the cartridge 2, and in this state, first lock members 63 exposed through cavities 73 and 72 of the A-side 2a and the B-side 2b of the cartridge 2 are slid toward a rear side in the cartridge loading direction. In this way, the shutter 13 is locked in the closed position by the lock mechanism which is released by two-step operation. Thus, the shutter 13 is prevented from being carelessly opened.

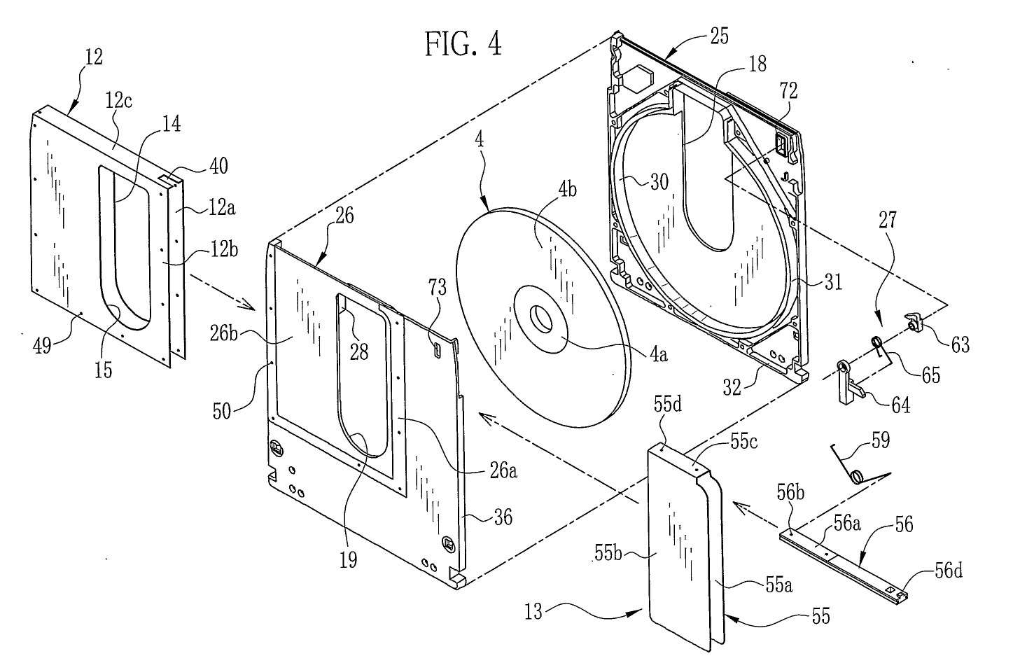

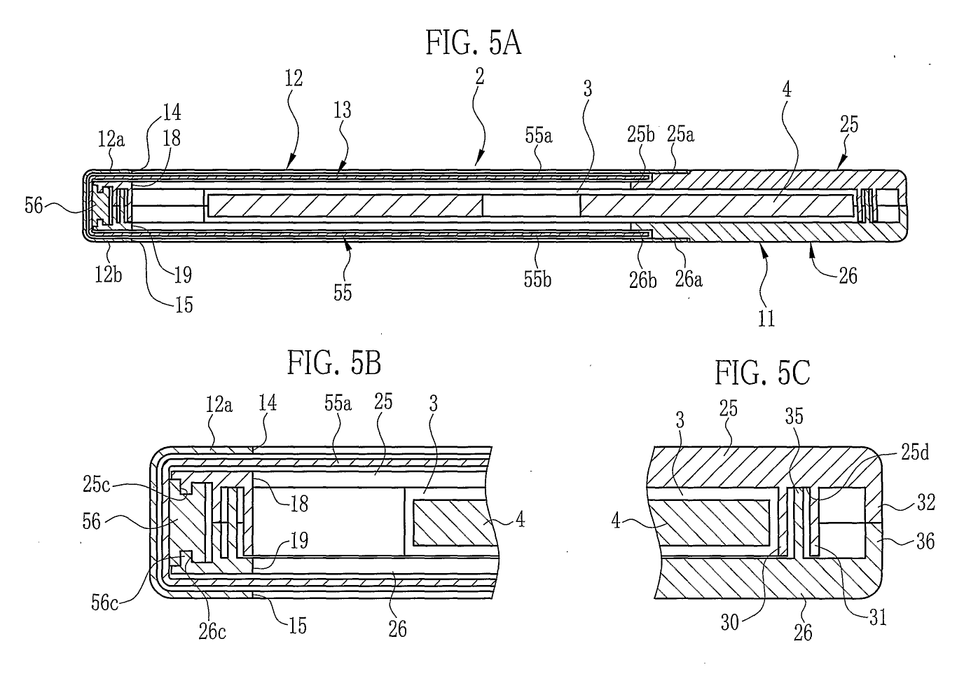

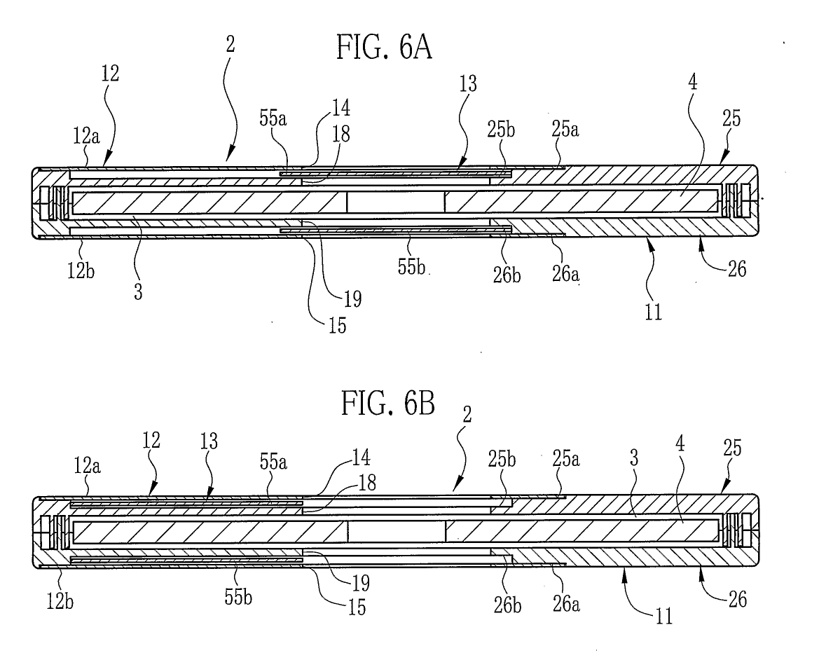

FIG. 4 is an exploded perspective view showing a structure of the cartridge 2. FIGS. 5A to 5C are section views of the cartridge 2 taken in the loading direction. FIGS. 6A and 6B are section views of the cartridge taken in a direction perpendicular to the loading direction. The cartridge shell 11 is composed of a first shell half 25 substantially having a plate shape, a second shell half 26 joined to the first shell half 25, and a lock mechanism 27 disposed between the first and second shell halves 25 and 26. The lock mechanism 27 locks the shutter 13.

For example, the first and second shell halves 25 and 26 are formed by means of injection molding and by using same or similar thermoplastic in which light-shielding substance and lubricant are added. FIG. 5C is an enlarged section view showing an edge portion of the cartridge 2. Such as shown in this drawing, an inner surface of the first shell half 25 is provided with a first light-shielding wall 30, a second light-shielding wall 31 and a first ridge 32. The first light-shielding wall 30 is formed so as to have a diameter larger than an outside diameter of the recording disk 4. The second light-shielding wall 31 is formed at the outside of the first light-shielding wall 30. The first ridge 32 is formed along the entire peripheral edge. At the inside of the first light-shielding wall 30, the internal opening 18 is formed to expose the central portion 4a and the recording surface 4b of the recording disk 4 to the outside.

An inner surface of the second shell half 26 is provided with a third light-shielding wall 35 and a second ridge 36. The third light-shielding wall 35 is formed so as to have a diameter larger than the outside diameter of the recoding disk 4, and is inserted into a space formed between the first and second light-shielding walls 30 and 31 of the first shell half 25. The second ridge 36 is formed along the entire peripheral edge. At the inside of the third light-shielding wall 35, the internal opening 19 is formed to expose the central portion 4a and the recording surface 4b of the recording disk 4 to the outside.

The recording disk 4 is placed on the inside of the third light-shielding wall 35 of the second shell half 26. Upon superposing the first shell half 25 on the second shell half 26, the third light-shielding wall 35 is inserted into the space formed between the first and second light-shielding walls 30 and 31. Further, the top of the third light-shielding wall 35 abuts on the inner surface of the first shell half 25. The disk recess 3 is formed by the light-shielding walls 30, 31, 35 and the inner surfaces of the first and second shell halves 25, 26. The lateral side of the disk recess 3 has a labyrinth-like light-shielding structure formed by combining the three light-shielding walls 30, 31 and 35. Thus, even if light and dust enter through a joint portion of the first and second shell halves 25 and 26, the light and the dust are prevented from reaching the inside of the disk recess 3.

The top of the third light-shielding wall 35 of the second shell half 26 is fixed to the inner surface 25d of the first shell half 25 by means of ultrasonic welding. In virtue of this, the first and second shell halves 25 and 26 are fixedly joined so that it is prevented to generate a gap at the joint portion thereof. Meanwhile, when performing ultrasonic welding, sometimes plastic powders scatter to a peripheral area. However, by performing the ultrasonic welding between the first and second light-shielding walls 30 and 31, the scatter is minimized so that the recording disk 4 is prevented from being dusty.

In a case that ultrasonic welding is performed for the first and second shell halves 25 and 26 after incorporating the shutter 13, the lock mechanism 27 and so forth in the cartridge shell 11, sometimes parts constituting the shutter 13 and the lock mechanism 27 are welded at the same time. In order to prevent this, a different kind of plastic from the first and second shell halves 25 and 26 may be used as the material of the parts constituting the shutter 13 and the lock mechanism 27.

As to a material of the light shielding plate 12, aluminum alloy is used, for example, since it is possible to obtain light-shielding properties, corrosion-resistance properties, decorativeness and workability, and since the aluminum alloy is light and strong. Incidentally, the light shielding plate 12 may be made of plastic. In this case, for the purpose of securing the light-shielding properties and sliding properties relative to the shutter 13, it is preferable to use a plastic including light-shielding substance and lubricant. The light shielding plate 12 is formed such that a thin plate of the aluminum alloy having the external openings 14 and 15 is bent so as to have a U-like shape. A cutout 40 for moving the shutter 13 is further formed in this thin plate. In other words, the light shielding plate 12 includes a first plate portion 12a and a second plate portion 12b, which have the external openings 14 and 15 respectively. The light shielding plate 12 further includes the cut out 40 and a connecting portion 12c connecting the first and second plate portions 12a and 12b.

The light shielding plate 12 interposes the B-side 2b and the A-side 2a of the cartridge shell 11 between the first and second plate portions 12a and 12b. Further, the light shielding plate 12 is attached to the cartridge shell 11 so as to cover the edge of the cartridge shell 11, which is located at the front side in the loading direction C, with the connecting portion 12c. Attachment surfaces 25a and 26a for attaching the light shielding plate 12 are formed on the outer surfaces of the first and second shell halves 25 and 26. The attachment surfaces 25a and 26a have a depth, which is deeper than a thickness of the light shielding plate 12, and are inwardly offset. Thus, the outer surface of the light shielding plate 12 attached to the cartridge shell 11 is adapted not to protrude from the surface of the cartridge 2.

Small holes 49 are formed at edge portions of the first and second plate portions 12a and 12b of the light shielding plate 12 at regular intervals. The attachment surfaces 25a and 26a of the first and second shell halves 25 and 26 are integrally formed with pins 50, which are located at positions corresponding to the holes 49 of the light shielding plate 12 and are slightly longer than the thickness of the light shielding plate 12. Upon attaching the light shielding plate 12 to the outer side of the cartridge shell 11, the pins 50 of the first and second shell halves 25 and 26 are inserted into the holes 49 and protrude from the surface of the light shielding plate 12. By deforming the tip of the respective pins 50 with heat, the light shielding plate 12 is fixed to the cartridge shell 11. As to other methods for fixing the light shielding plate 12 to the cartridge shell 11, it is possible to utilize an adhesive, a two-sided tape, a screw and so forth. In a case that the light shielding plate 12 is made of plastic, it is possible to utilize various kinds of welding.

The shutter 13 comprises a shutter member 55 and a slide member 56. The shutter member 55 is formed such that a thin plate having light shielding properties is bent in a U-like shape. The slide member 56 has a strip-like shape and is attached to the shutter member 55. For instance, the shutter member 55 is made of aluminum alloy for the similar reason with the light shielding plate 12. Incidentally, the shutter member 55 may be made of plastic. In this case, it is preferable that the plastic to be used includes light-shielding substance and lubricant for the purpose of securing light-shielding properties and sliding properties. The slide member 56 is made of plastic including light-shielding substance and lubricant.

The shutter member 55 comprises the first shutter portion 55a, the second shutter portion 55b and a connection member 55c. The first shutter portion 55a is inserted into a space formed between the outer surface of the first shell half 25 and the first plate portion 12a of the light shielding plate 12. The second shutter portion 55b is inserted into a space formed between the outer surface of the second shell half 26 and the second plate portion 12b of the light shielding plate 12. The connection member 55c connects the first and second shutter portions 55a and 55b. The slide member 56 is attached to the connection member 55c. On the outer surfaces of the first and second shell halves 25 and 26, shutter sliding surfaces 25b and 26b are formed at the inside of the attachment surfaces 25a and 26a. The shutter sliding surfaces 25b and 26b are inwardly offset so as to have a depth longer than a thickness of the shutter member 55. In virtue of this, the shutter 13 can smoothly move in the space formed between the cartridge shell 11 and the light shielding plate 12 so that shavings or the like to be caused by the movement are reduced. By the way, the shutter sliding surfaces 25b and 26b may be rough surfaces to diffuse incoming light. Similarly, the inner surface of the light shielding plate 12 and both surfaces of the shutter 13 may be also rough surfaces.

The slide member 56 is slidably interposed between the first and second shell halves 25 and 26, and an upper surface thereof is exposed from the edge surface of the cartridge shell 11, which is located at the front side in the loading direction. The upper surface of the slide member 56 is provided with a fitting surface 56a attached to an inner surface of the connection member 55c of the shutter member 55. For example, the fitting surface 56a is integrally formed with two pins 56b to be inserted into two holes 55d formed in the connection member 55c. By deforming the tip of the pin 56b with heat, the slide member 56 is fixed to the shutter member 55. Incidentally, for this fixation, it is possible to utilize an adhesive, a two-sided tape and so forth. In a case that the shutter member 55 is made of plastic, it is possible to utilize various kinds of welding. It is also possible to utilize a screw.

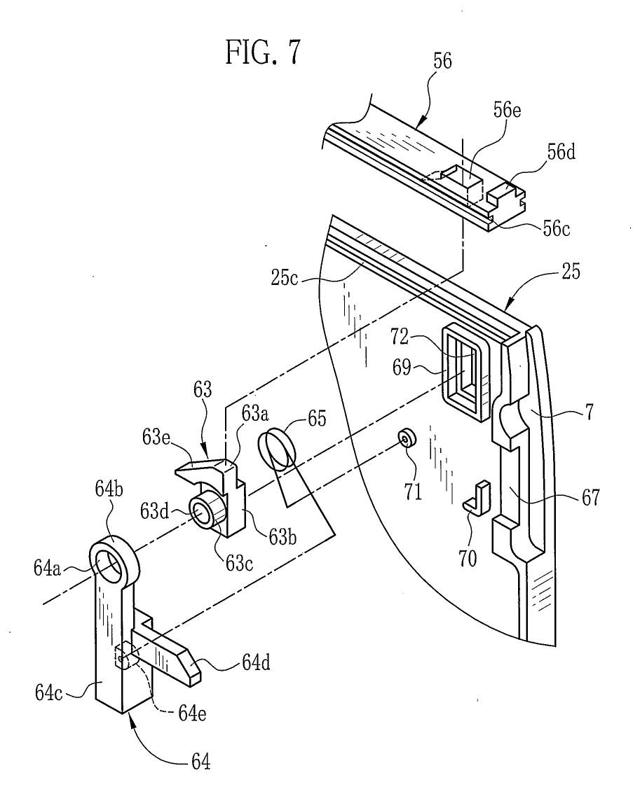

As shown in FIGS. 5B and 7, grooves 56c are formed in lateral sides of the slide member 56 in a longitudinal direction. Into the grooves 56c, are inserted ridges 25c and 26c formed on the front inner surfaces of the first and second shell halves 25 and 26 in the loading direction. By virtue of the grooves 56c and the ridges 25c and 26c, the slide member 56 can slide without slipping out of the cartridge shell 11.

The other end portion of the upper surface of the slid member 56 is integrally formed with an actuation part 56d to be operated for opening the shutter 13. The actuation part 56d is adapted to be exposed to the outside without hiding behind the connecting portion 12c of the light shielding plate 12. Such as shown in FIG. 3, the cutout 40 of the connecting portion 12c is formed for the purpose of preventing interference to be caused relative to the actuation part 56d at a time when the shutter 13 is moved to the open position.

The shutter 13 is urged by a shutter spring 59 in the closing direction. The shutter spring 59 is a torsion coil spring, for instance, and both ends thereof respectively engage with the slide member 56 and the inner surface of the first shell half 25.

The lock mechanism 27 is composed of the first lock member 63 for locking the shutter 13 in the closed position, the second lock member 64 for locking the movement of the first lock member 63, and a lock spring 65 for urging the second lock member 64 in a counterclockwise direction and in an upward direction.

The first lock member 63 comprises a lock claw 63a, a parallelepiped slide part 63b, a cylindrical boss 63c and an operation hole 63d. The lock claw 63a engages with a lock groove 56e, which is formed in the slide member 56, to lock the shutter 13 in the closed position. The slide part 63b is integrally formed with the lock claw 63a. The boss 63c is formed on a surface of the slide part 63b confronting the second shell half 26. The operation hole 63d is formed so as to penetrate the boss 63c and the slide part 63b. The lock claw 63a is provided with a slope 63e, which is formed to facilitate the engagement with the lock groove 56e at a time when the shutter 13 is moved from the open position to the closed position.

The second lock member 64 comprises a link part 64b, a rotary part 64c, a pressure part 64d to be pressed, and a spring retainer part 64e. The link part 64b has a hole 64a into which the boss 63c of the first lock member 63 is inserted in a state that the link part 64b is rotatable. The rotary part 64c is integrally formed with the link part 64b and is rotated around the boss 63c. The pressure part 64d perpendicularly protrudes from a lateral side of the rotary part 64c. The spring retainer part 64e retains one end of a lock spring 65.

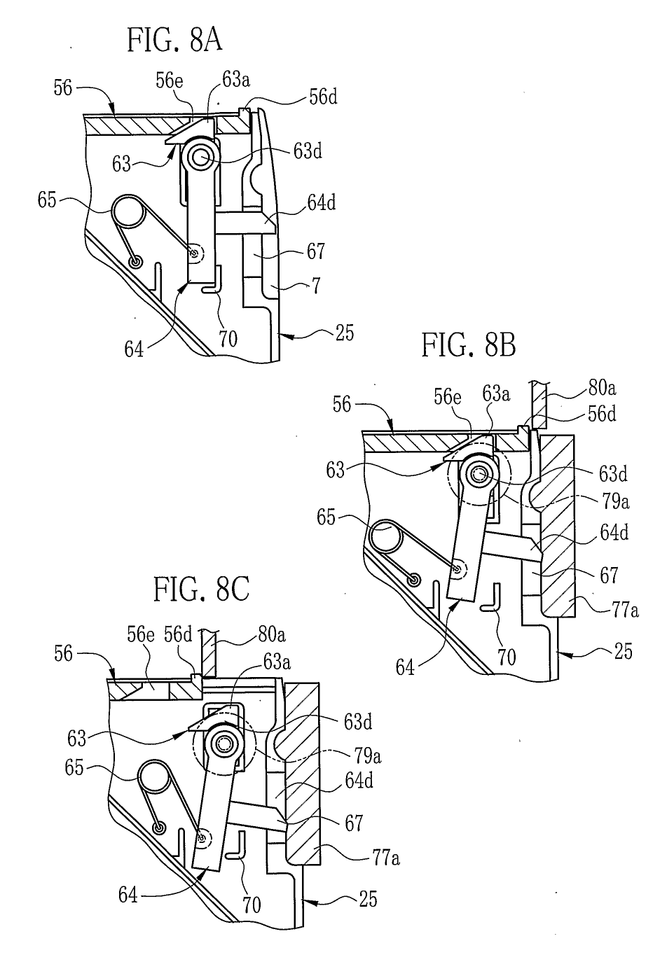

The first lock member 63 moves between a first lock position shown in FIG. 8A and a first release position shown in FIG. 8C. In the first lock position, the lock claw 63a engages with the lock groove 56e of the slide member 56. In the first release position, the lock claw 63a slides downward to release the engagement with the lock groove 56e. The second lock member 64 moves between a second lock position shown in FIG. 8A and a second release position shown in FIG. 8B. In the second lock position, the second lock member 64 is urged by the lock spring 65 to keep a vertical state. At this time, the pressure part 64d protrudes through a cutout 67 of the positioning groove 7. In the second release position, the second lock member 64 rotates in a clockwise direction in the drawing.

A rectangular frame 69, a regulation piece 70 and a boss 71 are formed on the inner surface of the first shell half 25. The slide part 63b of the first lock member 63 is inserted into the frame 69 so as to be vertically slidable. The regulation piece 70 receives one lateral side and the bottom of the rotary part 64c of the second lock member 64 to prevent this member 64 from rotating in a counterclockwise direction and sliding downward. The boss 71 retains the other end of the lock spring 65. The cavity 72 is formed in the frame 69 to expose the operation hole 63d of the first lock member 63 to the outside through the outer surface of the first shell half 25. Moreover, the cavity 73 for exposing the operation hole 63d to the outside is similarly formed in the second shell half 26 at a position confronting the cavity 72.

FIG. 8A shows the state of the lock mechanism 27 taken at a time when the cartridge 2 is not used. Since the second lock member 64 is urged by the lock spring 65 upward, the lock claw 63a of the first lock member 63 engages with the lock groove 56e of the slide member 56. In virtue of this, even if it is tried to slide the shutter 13 from the closed position to the open position, the engagement of the lock groove 56e and the lock claw 63a prevents the shutter 13 from sliding. Further, even if it is tried to slide the shutter 13 by inserting a rod or the like into the operation hole 63d of the first lock member 63 through the cavities 72 and 73 formed in the first and second shell halves 25 and 26, the lock is not released as the bottom of the second lock member 64 abuts on the regulation piece 70.

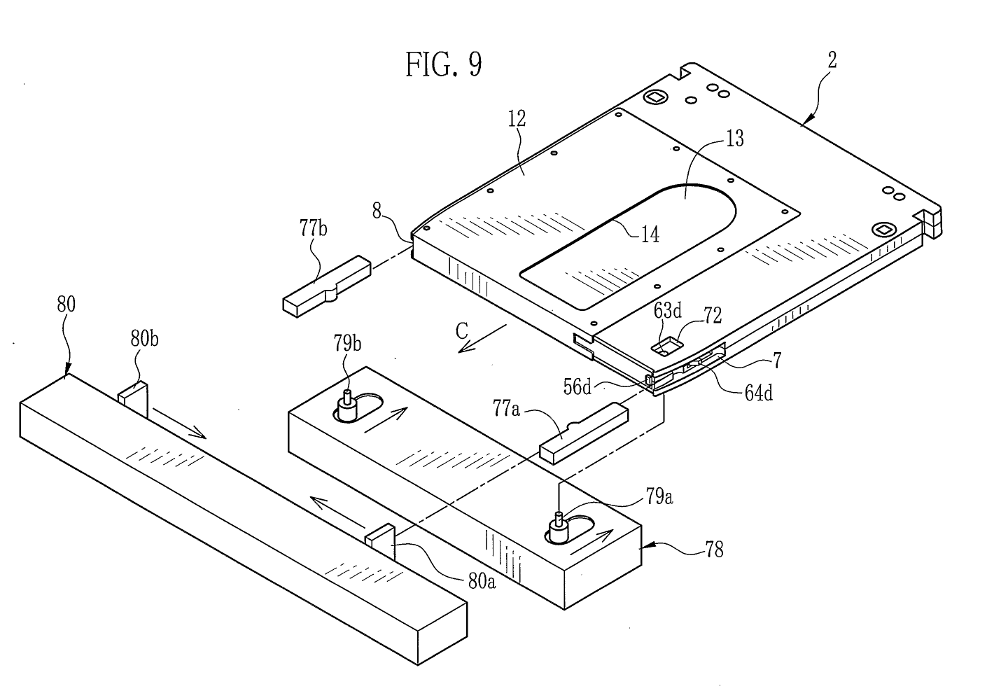

Such as shown in FIG. 9 for example, a hologram recording device, in which the cartridge 2 is loaded, includes a pair of positioning members 77a and 77b, a lock release mechanism 78 for operating the first lock member 63, and a shutter slide mechanism 80 for sliding the shutter 13 between the open position and the closed position. The pair of the positioning members 77a and 77b respectively engage with the positioning grooves 7 and 8, which are formed in both lateral sides of the cartridge 2, to set the position of the cartridge 2 in the loading direction of the cartridge 2 and in a perpendicular direction to the loading direction.

The lock release mechanism 78 comprises an engagement pin 79a and a slide mechanism. The engagement pin 79a is inserted into the operation hole 63d of the first lock member 63 through the cavity 73 of the cartridge 2. The slide mechanism slides the engagement pin 79a in a lock releasing direction of the first lock member 63. Meanwhile, it is possible to perform recording for both surfaces of the recording disk 4. Thus, the cartridge 2 is set to the device in a state that either of the A-side 2a and the B-side 2b faces upward. When the loading state is different, the position of the lock mechanism 27 is reversed in the right-and-left direction. In view of this, the lock release mechanism 78 comprises an engagement pin 79b, which is used at the time when the cartridge 2 is reversely loaded, so as to be capable of engaging with the operation hole 63d at that time. The engagement pins 79a and 79b are simultaneously moved in a direction shown by arrows. Incidentally, when one of the engagement pins engages with the operation hole 63d, the other thereof is impeditive. For this reason, it is preferable that the engagement pins 79a and 79b are adapted to be retracted when abutting on the cartridge 2.

The shutter slide mechanism 80 comprises an operation piece 80a for abutting on the actuation part 56d of the slide member 56, and a slide unit for sliding the operation piece 80a in the sliding direction of the shutter 13. The shutter slide mechanism 80 comprises another operation piece 80b for dealing with the reverse insertion of the cartridge 2. The respective operation pieces 80a and 80b are simultaneously moved in directions shown by arrows.

Upon loading the cartridge 2 into the hologram recording device, the positioning member 77a is inserted into the positioning groove 7 such as shown in FIG. 8B. Moreover, the engagement pin 79a of the lock release mechanism 78 provided in the device is inserted into the operation hole 63d of the first lock member 63, and the operation piece 80a of the shutter slide mechanism 80 is set at the outside of the actuation part 56d of the slide member 56. The positioning member 77a presses the pressure part 64d of the second lock member 64 against the urging force of the lock spring 65. The second lock member 64 rotates around the link part 64b in the clockwise direction, and the bottom of the rotary part 64c separates from the regulation piece 70. Consequently, the first lock member 63 becomes slidable in the downward direction.

As shown in FIG. 8C, the lock release mechanism 78 slides the engagement pin 79a in the releasing direction to release the engagement of the lock claw 63a and the lock groove 56e. After that, the shutter slide mechanism 80 slides the operation piece 80a in the left direction in the drawing, namely in the opening direction of the shutter 13. Thus, the shutter 13 is opened. In this way, the lock mechanism 27 is not released unless the second lock member 64 is rotated and the first lock member 63 is slid. It is effectively prevented that the shutter 13 is carelessly opened.

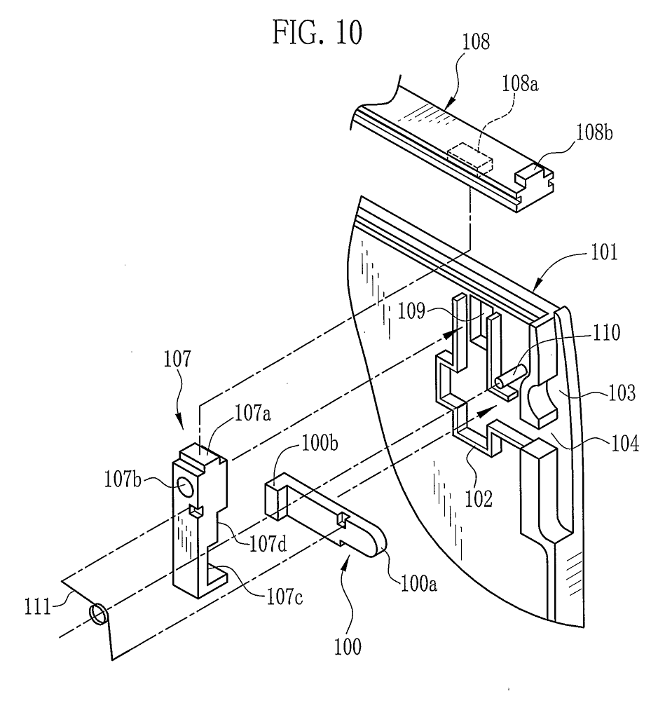

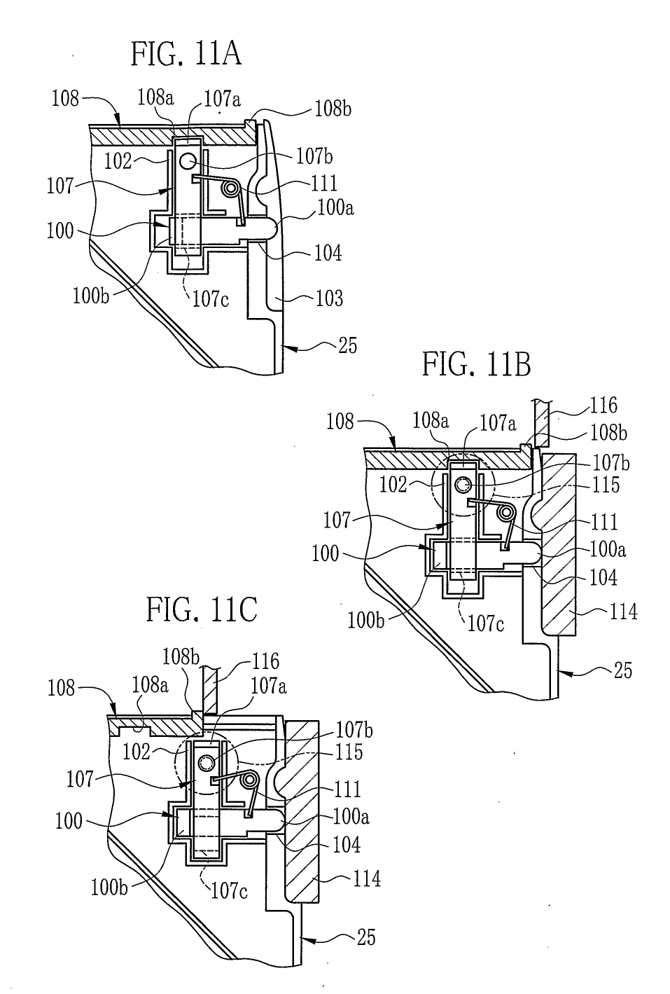

In the above embodiment, the second lock member is rotated. However, the second lock member may be slid similarly to the first lock member. FIGS. 10 and 11A to 11C show a structure of another lock mechanism in which the second lock member is slid. The second lock member 100 is contained in a frame 102, which is formed inside a first shell half 101, so as to be slidable in a lateral direction. The top 100a of the second lock member 100 is formed in an arc shape and projects to the outside through a cutout 104 formed in a positioning groove 103. A rear end of the second lock member 100 is integrally formed with a regulation protrusion 100b.

A first lock member 107 is contained in the frame 102 so as to overlap with the second lock member 100. The first lock member 107 is slidable in a vertical direction. The first lock member 107 comprises a lock piece 107a, an operation hole 107b and engagement grooves 107c and 107d. The lock piece 107a engages with a concave 108a of a slide member 108 to lock the shutter. The operation hole 107b is exposed to the outside through a cavity 109. The engagement grooves 107c and 107d are adapted to engage with the second lock member 100. The first lock member 107 and the second lock member 100 are urged by a lock spring 111, which is put on a pin 110, in an upward direction and in a right direction respectively.

As shown in FIG. 11A, the top 100a of the second lock member 100 is urged by the lock spring 111 and projects into the positioning groove 103 through the cutout 104 when the cartridge is not used. At this time, the regulation protrusion 100b of the second lock member 100 is fitted to the engagement groove 107c of the first lock member 107 to prevent the first lock member 107 from sliding downward.

As shown in FIG. 11B, the top 100a is pressed boa positioning member 114, which is inserted into the positioning groove 103, when the cartridge is loaded in the hologram recording device and so forth. Thereupon, the second lock member 100 is pushed into the cartridge to disengage the regulation protrusion 100b from the engagement groove 107c. Thus, the first lock member 107 is allowed to slide downward.

As shown in FIG. 11C, the lock release mechanism downwardly slides an engagement pin 115 engaging with the operation hole 107b. In association with this, the first lock member 107 slides downward without abutting on the second lock member 100 by virtue of the engagement groove 107d. In this way, the lock piece 107a disengages from the concave 108a of the slide member 108 so that the shutter becomes movable. An operation member 116 of the shutter slide mechanism presses an actuation part 108b of the slide member 108 to open the shutter. Also in the lock mechanism of this embodiment, two-step operation is necessary for releasing the lock of the shutter. Thus, it is possible to prevent the shutter from being carelessly opened.

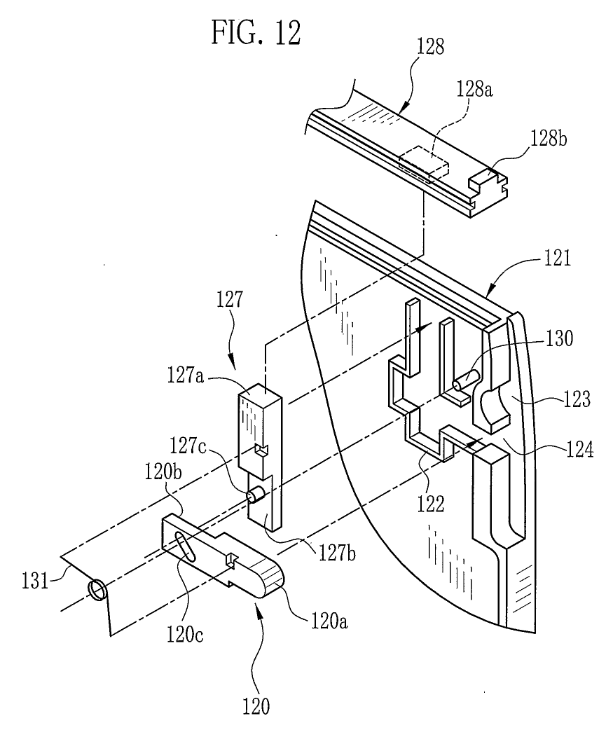

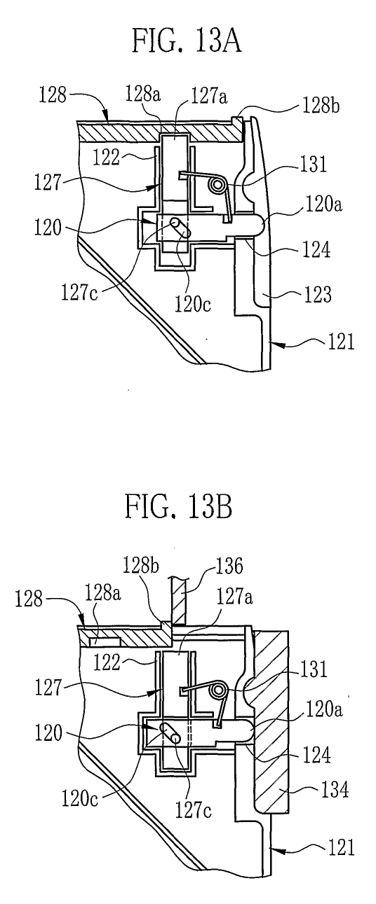

In the above embodiments, the two-step operation is performed for releasing the lock mechanism of the shutter. However, in a case that the member to be operated for releasing the lock is disposed at a place where erroneous operation is hardly performed, the lock may be released by one-step operation. As shown in FIGS. 12, 13A and 13B, a second lock member 120 is contained in a frame 122, which is formed inside a first shell half 121, so as to be slidable in a lateral direction. The top 120a of the second lock member 120 is formed in an arc shape and projects to the outside through a cutout 124 formed in a positioning groove 123. Further, an opposite side of the second lock member 120 is integrally formed with a cutout 120b and a diagonally-formed slit 120c.

A first lock member 127 is contained in the frame 122 so as to be laid under the second lock member 120. The first lock member 127 is slidable in a vertical direction. The top 127a of the first lock member 127 engages with a concave 128a of a slide member 128 to lock the shutter. An opposite side of the first lock member 127 is provided with a cutout 127b and a link pin 127c. The cutout 127b overlaps with the cutout 120b of the second lock member 120. The link pin 127c is inserted into the slit 120c. The first lock member 127 and the second lock member 120 are urged by a lock spring 131, which is put on a pin 130, in the upward direction and the right direction respectively.

As shown in FIG. 13A, the top 120a of the second lock member 120 is urged by the lock spring 131 and projects into the positioning groove 123 through the cutout 124 when the cartridge is not used. At this time, the slit 120c of the second lock member 120 presses the link pin 127c of the first lock member 127 to engage the top 127a of the first lock member 127 with the concave 128a of the slide member 128.

As shown in FIG. 13B, the top 120a is pressed by a positioning member 134, which is inserted into the positioning groove 123, when the cartridge is loaded in the hologram recording device and so forth. At this time, the slit 120c presses the link pin 127c to slide the first lock member 127 downward. In this way, the top 127a disengages from the concave 128a of the slide member 128 so that the shutter becomes movable. An operation member 136 of the shutter slide mechanism presses an actuation part 128b of the slide member 128 to open the shutter. In the lock mechanism of this embodiment, the member to be operated for releasing the lock mechanism is disposed in the positioning groove 123 where it is difficult to perform the operation from the outside of the cartridge. It is possible to prevent the shutter from being carelessly opened.

The plastic for forming the first and second shell halves 25 and 26 may include various substances as the light-shielding substance. It is preferable to add 0.01% to 5.00% by weight in accordance with the light-shielding substance to be used. For instance, carbon black is employed as the light-shielding substance. By adding the carbon black, it is possible to secure the light-shielding properties and to improve physical strength of the shell. A preferable amount of the carbon black to be added is 0.01 to 2.00 wt. %. When the amount of the added carbon black exceeds 0.01 wt. %, the light-shielding properties and the physical strength are improved. However, in case the amount of the added carbon black exceeds 2.00 wt. %, the physical strength deteriorates.

As the lubricant, silicone-based lubricants may be used, for example. By adding the silicone-based lubricant, frictional resistance is lowered. Thus, it is possible to reduce shavings to be caused by movement of the shutter 13. Moreover, it is also possible to reduce shavings to be caused at a time when the recording disk 4 comes into contact with an inner wall of the cartridge shell 11 due to a shock during transport. Further, handling for inserting the cartridge into the device is improved. Furthermore, flowability is improved so that kneading properties of a molding time, injection-molding processability and so forth are also improved.

A preferable amount of the silicone-based lubricant to be added is 0.1 to 3.0 wt. %. In case of 0.1 wt. % or less, there is no advantage. In case of 3.0 wt. % or more, the flowability becomes too excellent and slipping is caused between a screw and a resin at a time of kneading and molding. Due to this, the processability deteriorates. Further in this case, sometimes the lubricant bleeds out to a product surface and is transferred to the recording disk 4 and a hand of a user. As a result, troubles are caused regarding the handling properties and exterior appearance. By the way, when copolymer silicone is used, the lubricant may be added up to 5.0 wt. %, since the above-mentioned troubles are hardly caused.

### EXAMPLE

Next, examples of the present invention are described below. As to the thermoplastic for forming the first shell half and the second shell half, it is possible to use PBT, ABS, POM, PS, PP, HDPE, PA, PET, PPS, SAN (styrene-acrylonitrile copolymer), PMMA, PC and so forth. Meanwhile, with respect to the other parts except the first and second shell halves, it is desirable to select the different one, which is not used for the first and second shell halves, from among the above-noted thermoplastics for the purpose of preventing false ultrasonic welding.

It is preferable for the first and second shell halves to use a plastic having light-shielding properties of which visible-ray transmittance is 1.0% or less when a thickness is 0.2 mm. Further, it is preferable that the thickness is within a range of 0.2 mm to 1.6 mm in order to obtain necessary physical strength. For the purpose of obtaining the plastic having the above-mentioned light-shielding properties, various kinds of light-shielding substances maybe added. It is preferable to add the light-shielding substance by 0.01 to 5.00 wt. % in accordance with the one to be used. As the light-shielding substances, there are the following.

(1) Inorganic Compound

A. Oxide . . . silica, diatomous earth, alumina, titanium oxide, iron oxide(iron black), zinc oxide, magnesium oxide, antimony oxide, barium ferrite, strontium ferrite, beryllium oxide, pumice stone, pumice stone balloon, alumina fiber, and so forth.

B. Hydroxide . . . aluminum hydroxide, magnesium hydroxide, basic magnesium carbonate, and so forth.

C. Carbonate . . . calcium carbonate, magnesium carbonate, dolomite, dawsonite, and so forth.

D. Sulfate (Subsulfate) . . . calcium sulfate, barium sulfate, ammonium sulfate, calcium sulfite, and so forth.

E. Silicate . . . talc, clay, mica, asbestos, glass fiber, glass balloon, glass beads, calcium silicate, montmorillonite, bentonite, and so firth.

F. Carbon . . . carbon black, graphite, carbon fiber, carbon hollow sphere, and so forth.

G. Others . . . iron powder, copper powder, lead powder, aluminum powder, molybdenum sulfide, boron fiber, silicon carbide fiber, brass fiber, potassium titanate, lead titanate zirconate, zinc borate, barium metaborate, calcium borate, sodium borate, aluminum paste, talc, and so forth.

(2) Organic Compound

wood flour (pine, oak, sawdust and so forth), grain fiber (almond, peanut, chaff and so forth), cotton, jute, fine pieces of paper, non-wood fiber (straw, kenaf, bamboo, esparto, mulukhiya, firework and so forth), cellophane piece, nylon fiber, polypropylene fiber, starch (including denatured starch, surface treatment starch), aromatic polyamide fiber, and so forth.

Among the above light-shielding substances, the inorganic compound is preferable since this compound hardly causes a negative effect on the recording disk and is opaque in a thermally stable state at 150° C. or more. Especially, carbon black, titanium nitride, graphite, and iron black are preferable since these substances are excellent in heat resistance and light resistance, and are comparatively inactive.

When the carbon black is used as the light-shielding substrate, it is preferable that an amount of the carbon black to be added is 0.01 wt. % to 2.00 wt. %. This is for obtaining the plastic having a good balance regarding the light-shielding properties and the physical strength, such as mentioned in the foregoing.

As to classification of the carbon black in accordance with its raw material, there are gas black, furnace black, channel black, anthracene black, acetylene black, Ketjen carbon black, thermal black, lamp black, soot, turpentine soot, animal black, vegetable black, and so forth.

Regarding representative examples of marketed production of the preferred carbon black, there are carbon black #20(B), #30(B), #33(B), #40(B), #41(B), #44(B), #45(B), #50, #55, #100, #600, #950, #1000, #2200(B), #2400(B), MA8, MA11, MA100 and so forth manufactured by Mitsubishi Chemical Corporation. Moreover, it is also possible to use Denka Black manufactured by Denki Kagaku Kogyo, Seast manufactured by Tokai Carbon Co., Ltd., Asahi #78 manufactured by Asahi Carbon Co. Ltd., Showablack manufactured by Showa Cabot K. K., Niteron manufactured by Nippon Steel Chemical, and Diablack manufactured by Mitsubishi Chemical Corporation.

Besides the above, there are products manufactured by Cabot Corporation, for instance, Black Pearls 2, 46, 70, 71, 74, 80, 81, 607 and so forth, Regal 300, 330, 400, 660, 991, SRF-S and so forth, Vulcan 3, 6 and so forth, Sterling 10, SO, V, S, FT-FF, MT-FF and so forth.

Further, there are United R, BB, 15, 102, 3001, 3004, 3006, 3007, 3008, 3009, 3011, 3012, XC-3016, XC-3017, 3020 and so forth manufactured by Ashland Chemical Company. However, the present invention is not limited to the above-noted products.

Meanwhile, as to the lubricant to be added to the first shell half and the second shell half, it is possible to use silicone-based lubricant, especially, dimethylpolysiloxane of various grades. For instance, it is possible to use various grades marketed by Dow Corning Toray Silicone Co., Ltd., GE Toshiba Silicone Co., Ltd., Wacker Asahikasei Silicone Co., Ltd., Shin-Etsu Chemical Co., Ltd. and so forth. Incidentally, it is possible to use both of master batch and kneaded product. With respect to an amount of the silicone-based lubricant to be added, a range of 0.1 wt. % to 5.0 wt. % is preferable in order to obtain the plastic having a good balance regarding friction resistance, product quality and manufacture qualification.

As to the rough surface formed on the shell, if surface roughness Ra thereof is 5 μm or less, light diffusion effect is not sufficiently exerted. If the surface roughness Ra is 20 μm or more, the rough surface is likely to scratch the recording disk when coming into contact therewith. In view of this, it is preferable that mat processing or emboss processing is performed so as to make the surface roughness Ra 5 μm to 20 μm.

With respect to the aluminum alloy used for the light shielding plate 12 and the shutter member 55, Al—Mg alloys are preferable. For instance, JIS alloy Nos. 5052 and 5056 are preferable. In order to improve the strength, JIS alloy Nos. 5083 and 5086 are much preferable. In the case improving the strength, it is also preferable to use Al—Mg—Si alloys (JIS alloy Nos. 6063 and 6061, for instance), Al—Cu alloys (JIS alloy Nos. 2014 and 2017, for instance), and Al—Zn—Mg alloys (JIS alloy Nos. 7003, 7N01, 7075 and 7050, for instance). In view of weight saving and easy processing, it is preferable that a thickness of the light shielding plate 12 and the shutter member 55 is 1.0 mm or less, and it is much preferable that the thickness is 0.15 to 0.5 mm.

Incidentally, the light shielding plate 12 and the shutter member 55 may be made of plastic. For example, POM and so forth are suitable as the plastic to be used. Similarly to the first shell half and so on described above, the light-shielding substance and the lubricant may be added.

As for the shutter spring and the lock spring, it is preferable to utilize a stainless steel, which is used for an austenitic spring, in consideration of a spring constant, durability, processability and so forth. For instance, SUS 300s may be used. A preferable wire diameter of the shutter spring is 0.2 to 0.7 mm, and a preferable wire diameter of the lock spring is 0.15 to 0.4 mm.

Although the first and second shell halves are fixed by ultrasonic welding, other welding methods and other fixing methods may be adopted. For instance, the first and second shell halves may be fixed by a screw or the like. In this case, it is preferable to form a light shielding structure around a screw hole as well. Meanwhile, each of the first and second shell halves is composed of the sole part. However, the respective shells may be constituted by combining a plurality of parts. For example, in a case that the respective shells are composed of two parts divided at the shutter recess, molds thereof may be simplified.

The cartridge described in the above embodiments contains the recording disk, both surfaces of which are recordable. However, the cartridge may contain another recording disk, one surface of which is recordable. In this case, an opening is formed in only one side of the cartridge, and the shutter opens and closes this opening. Moreover, although the cartridge contains the hologram recording medium, the present invention may be adopted to another cartridge containing a recording medium having other photosensitivity.

### INDUSTRIAL APPLICABILITY

The present invention relates to a cartridge utilized in containing a photosensitive recording medium.

1. A cartridge used for a disk-shaped photosensitive recording medium, comprising:
a cartridge shell for rotatably containing said photosensitive recording medium;
a first opening formed in said cartridge shell;
a light shielding plate attached to an outer side of said cartridge shell;
a second opening formed in said light shielding plate so as to confront said first opening, a center and a recording surface of said photosensitive recording medium being exposed to the outside through said first and second openings; and
a shutter disposed between said cartridge shell and said light shielding plate, said shutter having a larger size in comparison with said first and second openings, and said shutter being movable between a closed position where said shutter is positioned between said first and second openings, and an open position where said shutter is moved from said first and second openings.

2. A cartridge according to claim 1, wherein said shutter has an actuation part to be operated, which is exposed to the outside of said light shielding plate, and said actuation part is operated to move said shutter between said closed position and said open position.

3. A cartridge according to claim 2, wherein said shutter includes a shutter member for closing said first opening, and a slide member fixed to said shutter member and moving along a lateral side of said cartridge shell, said actuation part being formed on said slide member.

4. A cartridge according to claim 1, further comprising:
a lock mechanism for locking said shutter in said closed position.

5. A cartridge according to claim 4, wherein said lock mechanism comprises:
a first lock member being movable between a first lock position for preventing movement of said shutter to said open position, and a first release position for allowing the movement of said shutter to said open position; and
a second lock member being movable between a second lock position for preventing movement of said first lock member to said first release position, and a second release position for allowing the movement of said first lock member to said first release position.

6. A cartridge according to claim 5, wherein said shutter includes a shutter member for closing said first opening, and a slide member fixed to said shutter member and moving along a lateral side of said cartridge shell, said first lock member engaging with said slide member to prevent the movement of said shutter to said open position.

7. A cartridge according to claim 6, wherein the top of said first lock member engages with a concave formed in said slide member.

8. A cartridge according to claim 5, wherein said second lock member includes a pressure part projecting to the outside of said cartridge shell, and said pressure part is pushed toward the inside of said cartridge shell to move said second lock member from said second lock position to said second release position.

9. A cartridge according to claim 8, wherein said cartridge shell further includes a groove and said pressure part protrudes inside said groove.

10. A cartridge according to claim 1, wherein said photosensitive recording medium is a hologram recording medium.

11. A cartridge according to claim 1, wherein:
said cartridge shell has first and second shell halves;
said shutter has a channel shape so as to straddle said cartridge shell;
said light shielding plate includes a first plate portion and a second plate portion, and has a channel shape so as to straddle said shutter.

12. A cartridge according to claim 11, wherein said first opening is formed in each of said first and second shell halves, and said second opening is formed in each of said first and second plate portions.
